(19) United States
(12) Patent Application Publication
(10) Pub. No.: US 2007/0299787 A1
(43) Pub. Date: Dec. 27, 2007

(54) SYSTEM, METHOD, AND COMPUTER PROGRAM FOR ANALYZING STOCKS

(76) Inventors: William H. Shelor, III, (US); William H. Shelor, Midlothian, VA (US)

Correspondence Address: Brian J. Teague;John H. Thomas, P.C., 536 Granite Avenue, Richmond, VA, 23226, US

(21) Appl. No.: 11/766,332

(22) Filed: Jun. 21, 2007

Related U.S. Application Data
(60) Provisional application No. 60/805,546, filed on Jun. 22, 2006.

(51) Int. Cl. G06Q 40/00

(52) U.S. Cl. 705/36 R

(57) ABSTRACT

A system and method wherein individual stocks within a portfolio are analyzed is disclosed. The user is permitted to vary which valuation metrics, or variables, which are used to analyze a particular stock. The user is further permitted to vary the weight or significance of the selected variables.

### CROSS-REFERENCE TO RELATED APPLICATIONS

This application claims priority to U.S. Provisional Application No. 60/805,546, filed Jun. 22, 2006, the contents of which are incorporated herein in its entirety.

### TECHNICAL FIELD

The present invention relates generally to determining values for securities, and more particularly, relates to methods, systems, computer program products, and business methods relating to valuation of individual data values based upon weighted variables.

### BACKGROUND OF THE INVENTION

In today's business world, vast networks of computers collect and store considerable amounts of raw data. As the costs associated with the collection of data decrease, coupled with the increased penetration of data collecting components in the stream of business computations and communications, the amount of raw data available for use has increased exponentially.

If mined properly, this raw data represents business intelligence that can be used to further refine business decisions to increase the accuracy and expediency of those decisions. In the modern age, where business transactions and events occur within milliseconds, the aforementioned business intelligence has become one of the most valuable resources available, potentially separating successful companies and individuals from those searching for any means to make a profit.

Although easy to explain in conceptual terms, because of the vast amounts of data collected, first mining the data to extract valuable business intelligence and, second, separating that information from business intelligence minded that is of little or no value to the corporation, is increasingly becoming cost and time prohibitive. To take advantage of the data collected in some manner, businesses are increasingly forced to reduce the scale upon which the data is mined, i.e., resorting to coarse granularity.

As an example, in the world of financial investing, there exists a myriad of stocks available for investing and copious amounts of data related to those individual stocks collected and stored. Because of the amount of information available to investors, the analysis of stocks can be a time consuming affair, potentially costing a significant amount of money and resulting in little to no gain. This represents a significant risk and cost to both corporate and individual investors.

To reduce the time and effort spent in selecting a particular security from the multitude of securities available on the various stock exchanges, and thus reducing the risk, investors generally use two, coarse-grained methods: screening stocks and asset allocation. To screen stocks, the investor selects certain filtering criteria that eliminate stocks that do not meet the specified criteria. As an example, a money manager may wish to screen stocks based upon a particular industry, a range of price/earnings ratios, or a range of debt/equity ratio.

In combination with the screening of stock, financial planners may also use asset allocation principles to determine investing patterns based upon the risk profile given to a particular investor. Investors use asset allocation, which is investment in a mixture of asset classes, because asset values typically vary year to year, thus making it difficult to predict which individual assets may be the top performers.

Additionally, there is a vast amount of data that can direct the investor to reasonable probabilities of success or failure in both individual components and broader based allocation portfolio decisions. The first step is to determine whether a problem truly exists not just with a certain component of the portfolio, but also with the portfolio itself.

Tracking the portfolio over customized time frames and allowing for alternative allocation models against the exact industry/index parallel depicts precise relevant performance far superior to broad-based identification and comparison of the same securities such as the S&P500, e.g. Broad Asset Allocation.

Broad Asset Allocation decisions are determined tluouglh typical and widely accepted methods such as the “Efficient Frontier” as related to Risk/Goal Analysis. Asset classes such as Large Capital (Growth, Small Capital Value, Corporate Bonds, etc. are readily tracked historically and forecasted accordingly to fit the goals of the investor. Comparisons of the current portfolio to an optimized model portfolio are a natural process resulting from the investor's parameters.

Board Asset Allocation decisions and basic screening methods, while important to an optimized portfolio, can only truly help the investor if the components, i.e. stocks or securities, of each class are effectively evaluated. Decisions within the recommended broad asset classes are where the true value exists, i.e. a fine-grained method in lieu of the coarse-grained methods described above. Amateur as well as sophisticated investors need to know what specific securities to own within the recommended category where ETF based, Mutual Fund, Fixed Income, or Individual Stock, etc.

Screeners and broad asset allocation forecasting tools in the current art, by themselves, do not effectively offer the fine-grained capability of evaluating the components of each class. Additionally, current art methods for data mining are cumbersome and costly, especially if a significant amount of resources are allocated to retrieve useless information. Also, significant resources may be expended before the investor realized that the current activity more than likely results in little to no useful intelligence.

Further, current art methods do not permit the freedom of variable weights for certain metrics necessary to evaluate individual components based upon user intent or experience. Additionally, current art methods do not permit a business model wherein business intelligence is used to determine the variable weights, wherein the resulting collecting of selected variable and their respective weights can be used for profitable gain.

Therefore, it would be beneficial to have a system, method, computer program, and business method that overcomes the limitations of the prior art, namely, the inability to effectively and efficiently evaluate individual components of a particular class of data points, unproductive data mining wherein the likelihood of lost resources is minimized, the inability to provide for a degree of variability for the evaluation, and the inability to create a business model based upon the integration of business intelligence into the determination of variable weights.

### SUMMARY OF THE INVENTION

Briefly described, in a preferred embodiment, the present invention overcomes the above-mentioned disadvantages and meets the recognized need not met by the prior art by providing for a system, method, computer program, and business method that effectively and efficiently gives the user the ability to evaluate, or score, individual components of a data class, then seamlessly integrate the evaluation into a broader evaluation activity.

In a preferred embodiment, the present invention is used to mine data for business intelligence relating to financial investments, though it should be understood by those of ordinary skill in the art that the present invention can be applied to other industries wherein large amounts of raw data exist that can be mined for useful business intelligence, including, but not limited to, the insurance, drug/pharmaceutical, and energy/oil industries.

In the present invention, business intelligence is built into the system at the coarse-grained level that facilitates effective data mining at the fine-grained level. Instead of using the current art methods for data mining, wherein the data is collected and sorted to find mathematical relationships, the present invention mines the data and retrieves values based upon predetermined variables, the variables themselves representing intelligence.

For example, a source of data may contain four classes or types of data. As discussed above, current art methods may sort through the data, applying algorithms in an attempt to determine if any relationships exist between the data. The result may be a significant number of relationships, thus forcing the user to go back and determine if those relationships actually provide any value. Thus, in the current art, business intelligence known at the time is not applied until after the data is mined. If the scenario is expanded into the current world of data collection, the current art methods can result in millions of useless relationships or values.

The present method, instead, integrates already known business intelligence into the system prior to data mining. The present invention integrates intelligence such as which data may be useful for a particular purpose, which data is not useful for that particular purpose, the significance of the data that is useful, and the significance of the relationships mined from that data. In this manner, the mining of data is done in an efficient and effective manner, thus reducing the costs, both time and money, associated with data mining.

In a preferred embodiment of the present invention, financial data is mined to determine a value for a particular security. This value may then in turn be used to determine any action, if necessary, that the investor may want to make regarding not only the security, but also its effect on a larger scale, more particularly, with the board portfolio management.

No only does the present invention provide for a higher level of accuracy when evaluating stocks, but, by providing a means to change the manner in which the individual stocks are evaluated by changing the intelligence built into the system, the present invention permits a degree of freedom to tailor the investment analysis to the user's particular investing needs.

In a preferred embodiment of the present invention, the intelligence built into the system prior to stock evaluation is accomplished by predetermining which stock data is used, what calculations are to be performed on the selected stock data, and the weight or significance given to each calculation with respect to the overall evaluation of the stock.

In a preferred embodiment of the present invention, the result of the individual calculations is combined to create an overall score for the stock, the score representing the strength or weakness of the stock. Therefore, the score can be used by the investor to determine if the stock should be bought, sold, or held. Additional advantages of the present invention include providing the investor with the ability to examine each individual calculation as well as compare the individual calculations with other metrics to provide additional investing information.

Further advantages of the present invention include the ability to generate value from the business intelligence used by the present invention prior to data mining, wherein the user may license, among others, the information regarding which stock data is used, what calculations are to be performed on the selected stock data, and the weight or significance given to each calculation with respect to the overall evaluation of the stock.

In general, in one aspect, the invention features a computer system for analyzing individual stocks using variables, said system including a means for selecting variables, a means for assigning weights to said variables, a means for downloading data and a means for evaluating said variables using said downloaded data.

In one implementation, variables are selected based on desired portfolio management goals and styles.

In another implementation, the variables are fundamental variables.

In another implementation, the fundamental variables are selected from the group consisting of financials, valuations, profitability and growth.

In another implementation, the variables are technical variables.

In another implementation, the weighted variables are chosen to obtain a simulation of stock performance.

In another implementation, the simulated stock performance is a score.

In another implementation, the score is a number used to determine to perform at least one of buy, hold and sell.

In another implementation, each of the chosen variables is assigned a portion of the score.

In another implementation, the score is determined by the assigned weight to each of the selected variables.

In another implementation, the assigned weights are percentages that total 100%.

In another aspect; the invention features a method implemented by a computer system for analyzing individual stocks using variables, said method including selecting desired variables, assigning weights to said variables, downloading data and evaluating said variables using said downloaded data.

In another aspect, the invention features a computer program for analyzing individual stocks using variables, said computer program including a first instruction set for selecting desired variables, a second instruction set for assigning weights to said variables, a third instruction set for downloading data and a fourth instruction for evaluating said variables using said downloaded data.

In another aspect, the invention features a business method, said method including determining optimal variables and optimal weights for a particular investing strategy and licensing said optimal variables and said optimal weights.

In another aspect, the invention features a method of evaluating security performance, including identifying a security of interest, identifying variables of interest that are associated with the security, assigning a percentage weight to the variables of interest, using the variables to generate a score, using the weight of the variables to determine a score aggregate and using the score to determine a security strategy.

In one implementation, the method further includes identifying a date of performance.

In another implementation, the method further includes generating a results percentile on the date of performance.

Accordingly, a feature and advantage of the present invention is its ability to provide a system, method, computer program, and business method for financial investing.

Another feature and advantage of the present invention is its ability to provide a system, method, computer program, and business method wherein individual stocks are evaluated or scored based upon selected variables.

Still another feature and advantage of the present invention is its ability to provide a system, method, computer program, and business method wherein individual stocks are evaluated or scored based upon variables having selected weights.

Yet another feature and advantage of the present invention is its ability to provide a system, method, computer program, and business method wherein individual stocks are evaluated or scored based upon variables having selected weights, wherein the data used may be either fundamental data or technical data.

Yet still another feature and advantage of the present invention is its ability to provide a system, method, computer program, and business method wherein a portfolio may be analyzed at the level of individual stocks based upon variables having selected weights, wherein the data used may be either fundamental data or technical data.

A further feature and advantage of the present invention is its ability to provide a system, method, computer program, and business method wherein a set of preferred variables and a set of preferred weights applied to those variables may be developed using business intelligence, experience, data mining, or other means of generating a preferred set of variables and weights.

Still a further feature and advantage of the present invention is its ability to provide a system, method, computer program, and business method wherein the preferred set of variables and the preferred set of weights are licensed to users.

Yet still a further feature and advantage of the present invention is its ability to provide a system, method, computer program, and business method wherein the preferred set of variables and the preferred set of weights are licensed to users at variable levels of accuracy or detail.

These and other objects, features, and advantages of the invention will become more apparent to those ordinarily skilled in the art after reading the following Detailed Description and Claims in light of the accompanying drawing Figures.

### BRIEF DESCRIPTION OF THE DRAWINGS

Accordingly, the present invention will be understood best through consideration of; and reference to, the following Figures, viewed in conjunction with the Detailed Description of the Preferred Embodiment referring thereto, in which like reference numbers throughout the various Figures designate like structure and in which:

FIG. 1 is an overall component diagram of the system, in accordance with one embodiment of the present invention;

FIG. 2 is a flow chart of the process for downloading data to be used by the system of FIG. 1;

FIG. 3 is a flow chart of the process for selecting variables and evaluating securities; and

FIGS. 4-16 are screen shots from a computer program implementing an embodiment of the present invention.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose.

It should be noted that the present invention may be implemented in one or more components, and any separation or combination of components described below is not intended in any way to limit the components to that particular combination. Further, the component functions described below may also be implemented tluough various types of embodiments, including, without limitation, software, firmware, or hardware, and any use of any one of the foregoing types of embodiments to describe the components is not intended in any way to limit the scope of the present invention.

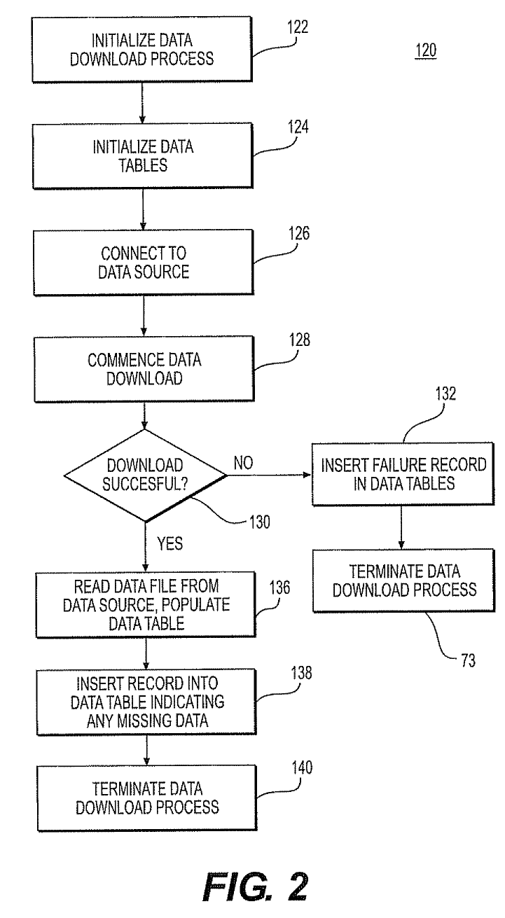

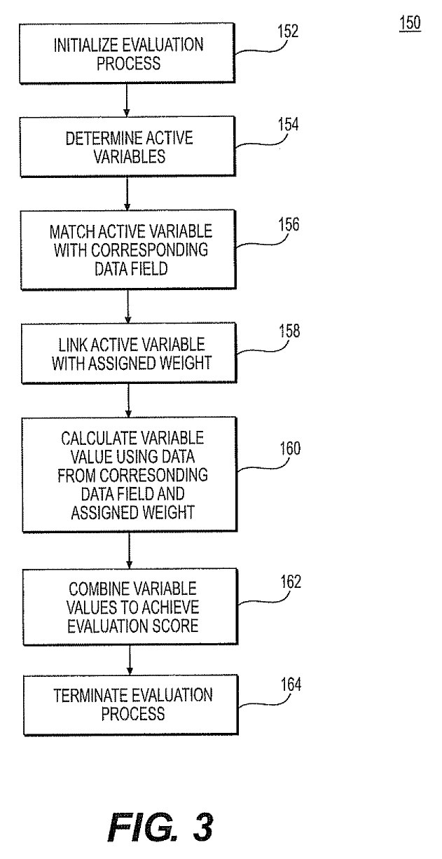

It should be further noted that the process steps of FIGS. 2 and 3 are described to be sequential. It has been contemplated, and considered to be within the scope of the present invention, that various process steps of FIGS. 2 and 3 can occur simultaneously, either in whole or in part, as well sequentially, and any description of the process occurring as such is not intended in any way to limit the scope of the present invention.

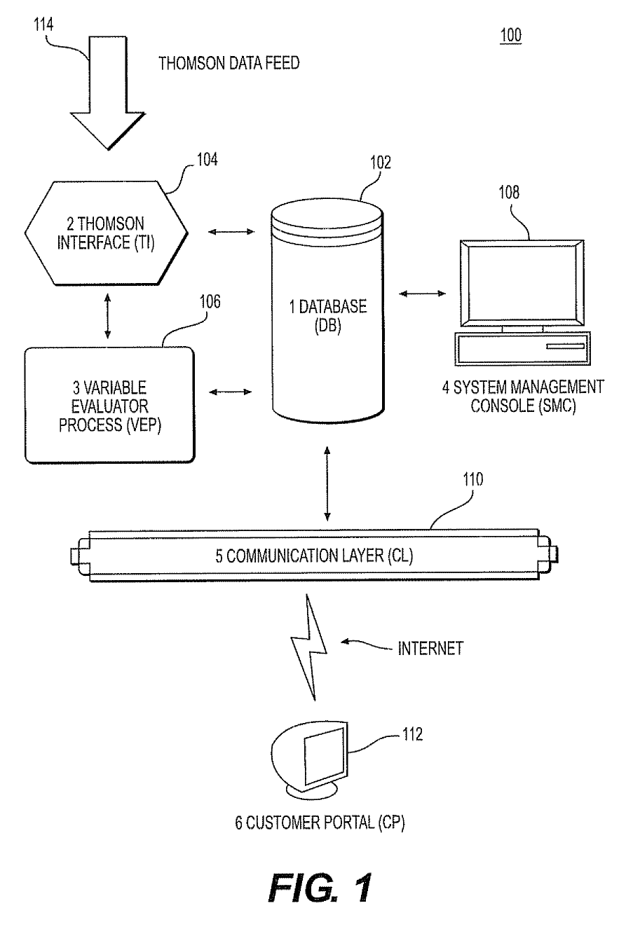

In that form of the preferred embodiment of the present invention chosen for purposes of illustration. FIG. 1 shows the component diagram of a system 100 of the present invention incorporating features of the preferred embodiment of the present invention. Generally, system 100 comprises database 102 (“Database” or “DB”), data interface 104 (“Thompson Interface” or “TI”), variable evaluator process 106 for evaluating and scoring each evaluation variable (EV), a user interface, such as a system management console 108 (“System Management Console” or “SMC”), communication layer 100, a presentation layer component, such as a customer portal 112, and data feed 114.

In more detail, database 102 stores all data elements and performs general data management functions. Further, some of system 100 processing is performed by database 102 using stored procedures. Data interface 104 receives data from data feed 114, performs preliminary processing of received data and store results in data tables. Data interface 104 performs all required filtering, mapping and conversion of received data, and makes the results ready for processing.

Variable evaluator processor 106 performs evaluation and scoring of each variable for every security maintained. Variable evaluator processor 106 store evaluation results with associated data stamp, creating a stored record, wherein each stored record can be indexed for retrieval. System management console 108 is a user interface that performs all required management of data elements, evaluation parameters, user accounts and other system components.

Customer portal 112 is the presentation layer component that provides a rich browser based environment for user access to system 100. This component preferably is developed using ASP.NET. Communication layer 110 is a WEB Service based component that facilitates two-way communications between the customer portal 112 and the rest of system 100 components, WEB Services technology allows secured communication over the Internet, enabling customer portal 112 to be separated from the rest of the components and be commercially hosted.

In a preferred embodiment, the present invention is implemented through a web-based portal. Other embodiments have been contemplated and are considered to be within the scope of the present invention, embodiments including a discrete, stand-alone module wherein data is downloaded and processed by the user's network or computer.

With reference to FIG. 2, process 120 illustrates a method for retrieving and downloading data used in the present invention. Download process 120 is first initialized in step 122. After initialization, data tables are initialized in step 124. Once the data tables are initialized, at step 126, process 120 connects to the data source and commences data download at step 128. If the download is unsuccessful, determined at step 130, a record is inserted into the data tables at step 132 and download process 120 is terminated at step 132.

If the download is successful, as determined at step 130, the downloaded data is read from the data source and the data tables are populated at step 136. Although step 136 is described in the present invention to follow step 130, it has also been anticipated and considered to be within the scope of the present invention for steps 130 and 136 to occur nearly simultaneously to reflect a real-time, first-in-first-out data population. In other words, as the data is downloaded in step 130, process 120 continues simultaneously with step 136.

Upon completion of step 136, if any data is missing, a record is inserted in the data table at step 138 indicating that an incomplete data download condition exists. At this point, download process 120 is complete and the process is terminated at step 140.

Once the data has been downloaded pursuant to download process 120, the user can then evaluate securities through evaluation process 150 (illustrated in FIG. 3). Process 150 is initialized at step 152. After evaluation process 150 is initialized, a user selects, at step 154, from a list of variables which variables is used to evaluate the securities.

After the user selects the variables to be used in step 154, process 150 matches the selected variables at step 156 with the corresponding data field contained within the data downloaded pursuant to process 120. At step 158, the user assigns various weights to the selected data and evaluation process 150 links the assigned weights to the corresponding variables.

Evaluation process 150 then computes the individual variable values for a particular security using the corresponding data at step 160. There are only certain variables/data that influences an investor's ability to properly assess probabilities of future outcomes related to stock selection. The variables, while widely understood and accepted, are different in importance depending on the Style of Management deployed by the firm and/or individual portfolio manager. Scoring and weighing these variables/data proves invaluable to any style of money management.

Examples of styles of management are: Growth, Value, Technical, GARP, Large-Cap., Mid-Cap., Small-Cap., International, etc. Within any category of investment style, the scoring mechanism can be altered to fit the parameters of the management's criteria. The variables that make up the SCORE, are completely reversible and interchangeable. If the user scores these components accurately, the user can score and eventually validate the style of management accurately.

This can be simulated to determine the precise optimal mix of variables per style. The result is less volatility and a higher probability of out-performance relative to any established benchmark. Running a simulation to find the optimal combination or weighting of each variable dramatically adds to the performance efforts of any research or money management firm. To achieve these results, the present invention scores virtually every possible combination of data.

Upon completion of the individual variable value computation, an overall score is computed at step 162. In an alternative embodiment of the present invention, along with providing an overall score at step 162, to validate an investment decision, the percentiles of the various categories can be established and matched against the industry that was selected. This provides investors with the ability to quickly identify strengths and weaknesses according to the stock and the industry selected. Once the overall score is computed, evaluation process 150 terminates at step 164.

The advantages of a preferred embodiment of the present invention are preferably attained by providing the following: 1) a data structure and user input screen to enter and manage lists of securities and industries to be evaluated as well as to maintain the relationship between these entities; 2) a data structure and user input screen to manage lists of Evaluation Variables (EVs) along with the evaluation criteria and scoring formulas to be evaluated by this system; 3) a means for receiving and processing data input from a data source containing stock related data; 4) a process that evaluates each EV for each stock based on the EV evaluation criteria and scoring formulas and record the resulting scores with appropriate timestamp; 5) a data structure and user input screen to establish and manage customer accounts, including a list of variable available and their relative percentage based ratio to report a score based on the compilation of selected EVs for selected security; 6) a security feather that restricts customer access as needed; and 7) a customer WEB-Based portal to provide on-line (browser based) customer access to preferred embodiment of the present invention.

In a preferred embodiment of the present invention, the system processes can include the following steps:

Step 1—V Calc Loader

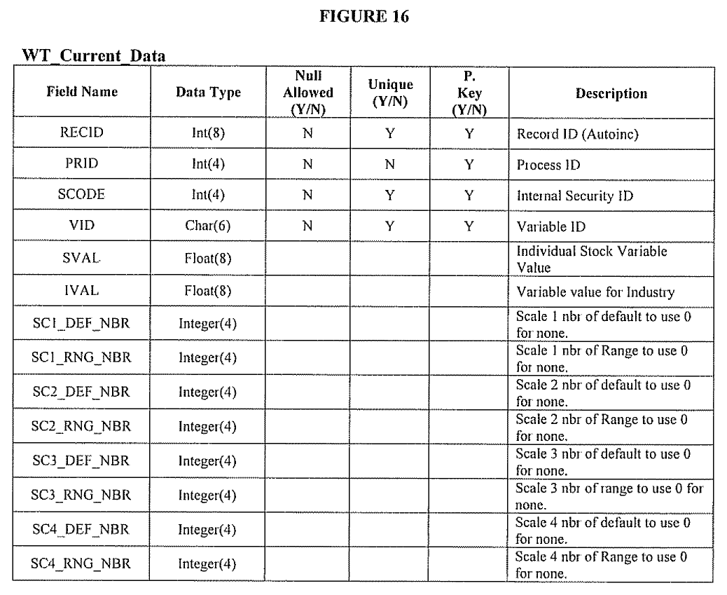

This step initiates the overall evaluation process. During this step the following data tables are initialized. TT_Process has a record added for the newly initiated process. 1_STEP field is set to 1. WT_Current_Data (illustrated in FIG. 16) has a record for each combination of Security and Variable is added. All records added are associated with the newly created process using PR_ID field. WT_Log_Header has a record added indicating the start of the new evaluation process. The WT_Log_Hdr table maintains the process log data. Each process has a header and a number of details. This table has a record for each phase of the calculation process.

Step 2—Data Reader

This step performs the actual parsing of the dialing data file downloaded from the data site and performs the following tasks: connect to the Thompson FTP site using data stored in the setup table, and start the file download; verify successful download of the file within the timeout period; if not, insert record into WT_Log_Header and terminate the process and Read data file and populate WT_Current_Data table. In general, this step reads data file and populates WT_Current_Data table as follows: for each Security/Variable combination update the IVAL and SVAL (Fundamental variables only) with Stock and Industry value provided by Thompson; check for all missing variables and remove the missing variable record from WI_Current_Data table; add a record to WT_Log_Detail table for each missing variable; check for any incomplete variables; and add a record to WT_Log_Detail table for each incomplete variable. The step can further insert a record into WT_Log_Header table indicating number of missing variables and number of incomplete variables (typically, fundamental variables only), and update TT_Process table by setting LSTEP field to 2.

In a typical implementation, inspection of the data indicates that up to 65% of the data is not needed or wanted (some of the stocks have been bought out or merged, some have market capitalizations too low for consideration, etc.).

In order to accommodate these issues, a typical embodiment contemplates that the Data Acquisition processes adapts to accept multiple files and an additional new process “cleans” the data before processing, thereby alleviating processing time concerns.

Data Acquisition

On the VEP processing screen, in the FTP File Name entry field, a user can add the ability to enter a list of filenames (10 maximum). The list of files is typically retained from one session to the next.

The system further provides access to the Thompson FTP site, A user can FTP and load into the Daily Data Table each CSV file in turn until all files have been loaded in the Daily Data Table. In addition, the step includes cleaning the Daily Data Table according to the criteria below. Typically, the steps then proceed to the Security, Industry Update step to complete VEP processing.

Clean Data Criteria

The system and methods described further include a step between UPDATE DAILY DATA FEED and UPDATE SECURITY, INDUSTRY that deletes records from the Daily Data Feed Table based upon the following: all data for any Security where VF0074=“DEAD” should be deleted; add a place in the System Setup to enter this VID, label it “ACTIVE/DEAD VID”; and all data for any security where Market Cap (the Market Cap VID is obtained from the System Setup Table) is less than 50 (this number is typically configurable from the System Startup screen).

Step 3—Calc Mthd Finder

This process performs all logical evaluation necessary to determine a method of evaluation of each Variable Scale by determining which default or range is to be used, Only variable with MT_Variable_HDR.EVALUATE=“Y” are processed.

At the start of this process, a record is added to WT_Log_Header table. This function performs using the following set of tasks that is typically repeated 4 times (for each scale) for each record in the WT_Current_Data table associated with the current Process ID:
2 Evaluate Boolean conditions stored in DEF1_COND . . . DEF5_COND fields to determine if any of them evaluate to “True” then perform the following steps:
   a. Update current WT_Current_Data SCn_DEF_NBR field (“n” is the number of the scale being evaluated) with lowest default number that evaluated to “True”.
   b. If multiple defaults for a scale evaluate to “True” then a record is added to the WT_Log_Detail table indicating variable and scale that produced the error
   c. Scale evaluation is complete and the step 1 is repeated for the next scale or variable.
      This condition field can consist of the following variable symbols:
         i XXXXXX.S Value of the stock data where XXXXXX is variable id (VID) and can be omitted for current variable.
         ii. XXXXXX.I Value of the industry data where XXXXXX is variable id (VID) and can be omitted for current variable
         iii. Any Boolean operator (“or”, “and”, etc.)
         iv. Any arithmetic operator (“+”, “−”, etch)
         v. Any numeric constants
         vi. Field must evaluate to a Boolean (T/F) results.
3. If no default evaluated to “True” this step evaluates Boolean conditions stored in RNG1_COND . . . RNG4_COND fields to determine if any of them evaluate to “True” then perform the following steps:
   a. Update current WT_Current_Data SCn_RNG_NBR field (“n” is the number of the scale being evaluated) with lowest range number that evaluated to “True”.
   b. If multiple ranges for a scale evaluate to “True” then a record is added to the WT_Log_Detail table indicating variable and scale that produced the error.
   c. Scale evaluation is complete and the step 1 is repeated for the next scale or variable.
      This condition field can consist of the following variable symbols:
         i. XXXXXX.S Value of the stock data where XXXXXX is variable id (VID) and can be omitted for current variable.
         ii. XXXXXX.I Value of the industry data where XXXXXX is variable id (VID) and can be omitted for current variable.
         iii. Any Boolean operator (“or”, “and”, etch)
         iv. Any arithmetic operator (“+”, “−”, etc.)
         v. Any numeric constants
         vi. Field must evaluate to a Boolean (T/F) results.
4. When all record in the WT_Current_Data table are processed the following table updates are performed:
   a. A record is added to WT_Log_Header table indicating number of Default and Range errors.
   b. Update TT_Process table by setting LSTEP field to 2.
5. Upon completion of each record the last record processed is recorded in WT_Log_Header table.
6. Upon completion of this step the WT_Log_Header is updated
7. Update TT_Process table by setting LSTEP field to 3.

Step 4—VAR Evaluator

This step performs actual variable score evaluation. Only variables with MT_Variable_HDR.EVALUATE=“Y” are typically processed. All data developed during the prior step is used. At the beginning of this step a record is added to WT_Log_Header table. This step repeats the following tasks for each record in the WT_Current_Data table:
a. For each record in the WT_Current_Data perform the following calculations for each scale and record the result in the TT_Result table by adding a record for each record in WT_Current_Data, updating data as follows:
   a. Update SECID, VID and PRID field from the current record in WT_Current_Data.
   b. Update SROCALC and CFACTOR fields from the corresponding record in MT_Variable_HDR table.
2. For each Scale perform the following evaluation and update SCn_SCORE (where n is the scale number)
   a. If default number (other than 0) is recorded in the current record of WT_Current_Data for the scale being evaluated, then use the value of the DEFn_VALUE (where n is the default value record in the WT_Current_Data table) field from the corresponding record in MT_Variable_SCn (where n is the scale number) table.
   b. If Range is used, then evaluate the range selected in the current record of the WT_Current_Data table using the values stored in the IVAL and SVAL fields and RNGx_HCOND, RNGx_LCOND.
      This condition field can consist of the following variable symbols:
         i. XXXXXX.S Value of the stock data where XXXXXX is variable id (VID) and can be omitted for current variable,
         ii. XXXXXX.I Value of the industry data where XXXXXX is variable id (VID) and can be omitted for current variables
         iii. Any arithmetic operator (“+”, “−”, etc.)
         iv. Any numeric constants
         v. Field must evaluate to a numeric result.
      In general, range is evaluated using RNGx_EVAL value (consists of “S” for stock, “I” for industry and operators (e.g., S/I*100, etc.) by taking a linear function to determine the value by using a high value in HVAL and Low Value in LVAL fields and using EVAL value position between HCOND and LCOND values,
3. After all scales for the current record in WT_Cutrent_Data are evaluated the RESULT field of TT_Result table is updated.
4. The current record in WT_Log_Header is updated with the record id processed.
5. Upon completion of this step WT_Log_Header is updated.
6. Update TT_Process table by setting LSTEP field to 4.

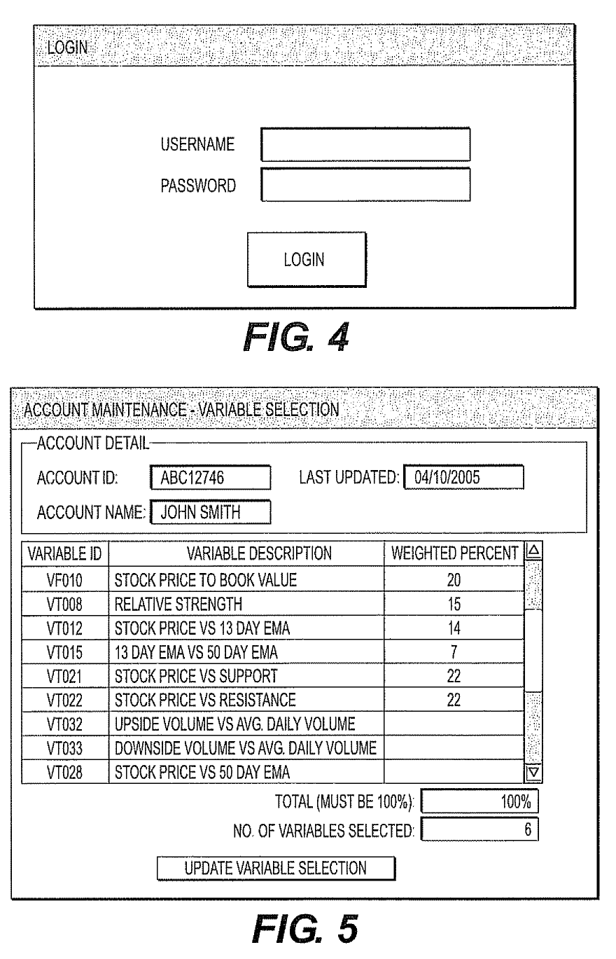

To access the preferred embodiment of the present invention, a user logs onto the system through a web-based customer portal, as illustrated in FIG. 4. The user's identify is authenticated, preferably though the use of a username and password, to provide for a level of security and privacy.

Once the user's identify is authenticated, the user is presented with a set of variables that are used by the system to score, or evaluate, a particular security based upon weights applied to the particular variable as inputted by the user. The variable selection/modification screen is illustrated in FIG. 5. The particular variables that the user selects as active (i.e., the users applies a weight greater than “0” to the variable) depends upon the user's desired functionality of the system as well as any limitations on the data provided to the system. This screen presents a list of all variables with an empty field next to each variable so that user can enter the percentage (system forces the total percentage of 100). This screen may be restricted to a specific number of variables (per user setup record).

Further details of the variable selection screen illustrated in FIG. 5 follow. The box against the text “Account ID” displays your Account ID. The box against the text “Last Updated” displays the date and time of your previous access to SSE. This field will be blank in case you are accessing the screen for the first time. The box against the text “Account Name” displays your Account Name. The Variable Selection table has tliree fields:
a. Variable ID: This field denotes the Serial Number of the variable. Variable ID starting with VF indicates that the variable is a Fundamental variable, Variable ID starting with VT indicates that the variable is a Technical variable.
b. Variable Description: This field describes what each variable stands for,
c. Weighted Percentage: This field allows you to allocate percentages to the variables of your choice. For the 30 days after your registration, you can select from all the 84 variables. After 30 days, you can select from only the variables allocated to you at the time of registration/account creation.

In the Weighted Percentage field, the default values visible are the ones that you entered during your last access, You can change the values by entering the percentages against different variables. The sum total of the percentages must be 100.

Changes may be saved by clicking the Update Variable Selection button. An Update Successful Message may appear if no problems occur. In case the sum total of the percentages is not 100, an error message may be displayed. To correct the error, the user may change the weighted percentage appropriately and click Update Variable Selection button again.

The variables preferably consist of two different types: fundamental and technical, A fundamental variable is a variable used to calculate certain values of a stock based upon data that is “fundamental” to the company. In other words, the variables are directly related to the company, e.g., earnings, dividends, and sales, A fundamental variable is not directly related to a broad analysis of the market and does not include behavioral attributes. IT other words, a fundament variable focuses on the business itself. Examples of fundamental variables include, without limitation, long-term debt to equity ratio, earnings growth averaged out to five (5) years, and inventory turnover ratio.

In one embodiment of the invention, the user may select from a choice of 84 variables: 48 fundamentals and 36 technicals. The following is a sample list of variables that may be used in embodiments of the present invention:

CASH MRQ: CASH/MAR.CAP.

LONG-TERM DEB/EQUITY

PRICE/5 YR. EST. GRTH RATE

PRICE/FORWARD EARNINGS

PRICE/EARINGS TTM

PRICE/SALES (REVENUE)

PRICE/BOOK VALUE

PRICE/CASH-FLOW

PRICE/FREE CASH-FLOW

OPERATING MARGIN TTM

OPERATING MARGIN TTM PC 1q

OPERATING MARGIN 3YR. AVG.

OPERATING MARGIN 5YR. AVG,

PROFIT MARGIN TTM

PROFIT MARGIN 3YR. AVG

PROFIT MARGIN 5YR. AVG

RETURN ON EQUITY TTM

RETURN ON EQUITY TTM PC 1q

RETURN ON EQUITY 3YR. AVG.

RETURN ON EQUITY 5YR. AVG.

REVENUE GROWTH TTM

REVENUE GROWTH TTM PC 1q

REVENUE GROWTH 3YR. AVG.

REVENUE GROWTH 5YR. AVG.

EARNINGS GROWTH TTM

EARNINGS GROWTH TTM PC 1q

EARNINGS GROWTH 3YR. AVG.

EARNINGS GROWTH 5YR. AVG,

ESTIMATED 5-YEAR EARNINGS GROWTH RATE

EBITDA GROWTH TTM

EBITDA GROWTH TTM PC 1q

EBITDA GROWTH 3YR. AVG.

EBITDA GROWTH 5YR. AVG,

CURRENT RATIO

SHARE HOLDER EQUITY/MARKET CAP. (MRQ)

FLOAT/SHARES OUTSTANDING

AVERAGE DAILY VOLUME/MARKET CAP,

TREASURY STOCK/SHARES OUTSTANDING

INVENTORY TURNOVER RATIO

DIVIDEND YIELD

SALES YIELD (E/P)

EARNINGS YIELD (E/P)

EARNINGS YIELD VS. LONG BOND YIELD

CASH-FLOW GROWTH TTM

CASH-FLOW GROWTH 3YR. AVG.

CASH-FLOW GROWTH 5YR. AVG.

OPER. MARGIN TTM VS, 3YR AVG. (EXPANSION)*

GROSS MARGIN TTM VS. 3YR AVG. (EXPANSION)*

PROFIT MARGIN TTM VS. 3YR AVG. (EXPANSION)*

EBIDTA MARGIN TTM VS. 3YR AVG. (EXPANSION)*

ROE TTM VS. 3YR. AVG. (EXPANSION)*

EARNINGS GROWTH TTM VS 3YR AVERAGE

SALES GROWTH TTM VS 3YR AVERAGE

NAME OF COMPANY

STOCK SYMBOL

EXCHANGE NAME

SEDOL

LOCAL CODE (CUSIP FOR US EQUITIES)

ISIN

TIME RECORDS THE DATE OF THE LATEST EQUITY PRICE DATA

DATE OF FICAL YEAR END

INTERIM DATA END DATE

ICB SECTOR CODE

ICB SECTOR NAME

GENERAL INDUSTRY CLASSIFICATION (FROM WS DATABASE)

INDUSTRY GROUP (FROM WS DATABASE)

INDUSTRY CLASSIFICATION BENCHMARK

PRICE (ADJUSTED)

UNADJUSTED PRICE

MARKET VALUE

RETURN INDEX

VOLUME

MEAN VALUE OF ALL FYI EPS ESTIMATES FOR A COMPANY

ACTIVE DEAD SUSPENDED

QUARTERLY CASH&SHORT TERM INVESTMENTS

TTM EPS

TRAILING TWELVE MONTHS GROSS MARGIN

TRAILING TWELVE MONTHS NET MARGIN

NET SALES/REVENUES

FUNDS FROM OPERATIONS

CAPITAL EXPENDITURES (ADDITIONS TO FIXED ASSETS)

CASH DIVIDENDS PAID

OPERATING PROFIT MARGIN

PRETAX MARGIN

RETURN ON EQUITY—TOTAL $

SALES PER SHARE

EARNINGS PER SHARE

GROSS PROFIT MARGIN

NET MARGIN

EBITDA

(CURRENT SHARE PRICE/13 DAY EMA)*100

(CURRENT SHARE PRICE/50 DAY EMA)*100

(CURRENT SHARE PRICE/200 DAY EMA)*100

**(13 DAY EMA/50 DAY EMA)*100

**(50 DAY EMA/200 DAY EMA)*100

STOCK PRICE VS. FULL STOCHASTIC (80 LINE) %

STOCK PRICE VS. FULL STOCHASTIC (20 LINE) %

STOCK PRICE VS RESISTANCE % DIFFERENTIAL

STOCK PRICE VS. SUPPORT % DIFFERENTIAL

AVERAGE DAILY VOLUME VS. PUBLIC FLOAT

NEW 52-WEEK HIGH VS. INDUSTRY 52 WEEK HIGH

NEW 52-WEEK HIGH VS. AVG. 52 WEEK STOCK P.

NEW 52-WEEK LOW VS, INDUSTRY 52-WEEK LOW

NEW 52-WEEK LOW VS. AVG. 52-WEEK STOCK P

S-P TOTAL RETURN VS. IND. TR 52-WEEK %

S-P TOTAL RETURN VS. IND. TR 13-WEEK %

S-P TOTAL RETURN VS. IND TR 1-MONTH %

S-P TOTAL RETURN VS. IND. TR 1-WEEK %

UPSIDE VOLUME SURGE (5 DAY AVG) VS. AVG. DAILY VOL.

DOWNSIDE VOLUME SURGE (5 DAY AVG) VS. AVG, DAILY VOL.

RELATIVE STRENGTH

STOCK PRICE VS. 52-WEEK AVG.

STOCK PRICE VS. 52-WEEK HIGH

STOCK PRICE VS. 52-WEEK LOW

CURRENT UPSIDE VOLUME SURVE VS. AVERAGE DAILY VOL.

CURRENT DOWNSIDE VOLUME SURGE VS. AVG. DAILY VOL.

MACD TRENDING (FAST LINE VS. SLOW LINE)

13-DAY EMA CROSSOVER 50-DAY EMA (UP OR DOWN)

50-DAY EMA CROSSOVER 200-DAY EMA (UP OR DOWN)

STOCK PRICE CROSSOVER 13-DAY EMA (UP OR DOWN)

STOCK PRICE CROSSOVER 50-DAY EMA (UP OR DOWN)

STOCK PRICE CROSSOVER 200-DAY EMA (UP OR DOWN)

S-PRICE CROSSOVER FULL STOCHASTIC 20 LINE (OS)**

MCCLELLAN OSCILLATOR CROSSOVER****

CURRENT VOLUME/AVG DAILY VOLUME (12 MONTH)

AVG DAILY VOLUME (12 MONTH)

13 DAY EMA

50 DAY EMA

200 DAY EMA

FULL STOCHASTIC 80% LINE

FULL STOCHASTIC 20% LINE

To further custom tailor the present invention to suit a particular investing method, the fundamental variables can be further broken down into sub-variables that reflect a particular investing strategy, including financial, valuations, profitability, and growth

A technical variable, on the other hand, is a variable that uses historical data and calculations to attempt to detect trends in the market as well as trends in individual stocks to predict future values. Technical variables do not take into account qualitative information regarding the company, but instead, focus on historical data. Examples of technical variables include, without limitation, the ratio of the current stock price to the 52 week average price, the thirteen (13) day exponential moving average (EMA), and the ratio of the stock price total return to the industry trend 1-week percentage.

Depending upon the user's preference and the weights given to particular variables, the user can custom-tailor the preferred embodiment of the present invention to calculate variables based upon certain fundamental or technical data, or any combination thereof.

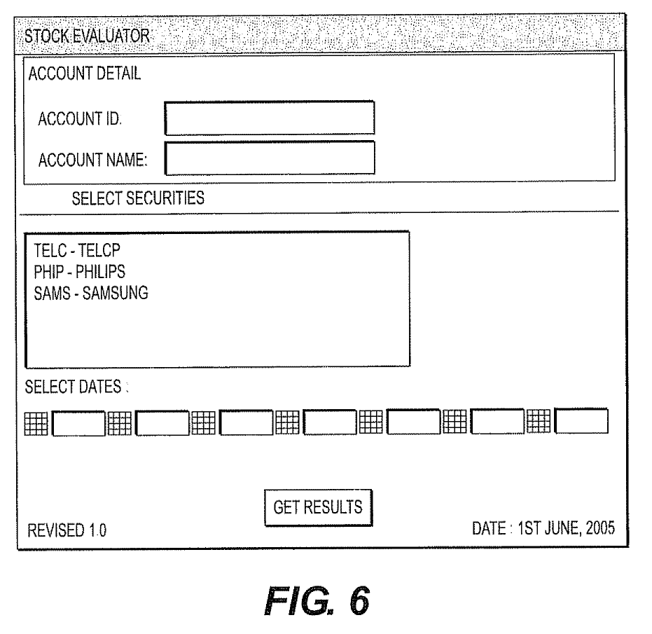

Once the user inputs weights to the selected variables to reflect a particular investing strategy, the user then commences selecting various securities and dates of scoring. The stock selection screen is illustrated in FIG. 6. The user can select either one or multiple stocks, depending on their investing strategy. After the stocks are selected, the present invention then scores each stock from within a range of values, preferably 0-1000, using the variables selected as active and their corresponding weights.

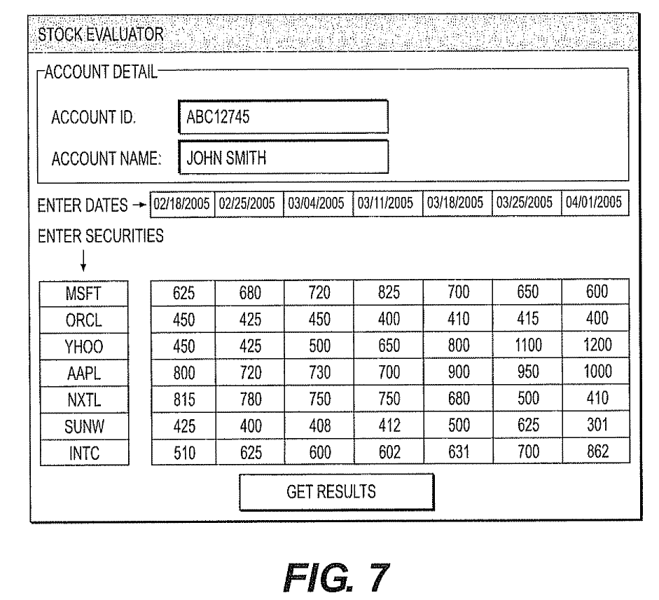

The user is then presented with the results of the scoring. The scoring display screen is illustrated in FIG. 7. In a preferred embodiment of the present invention, a scoring range of 0-1000 is used, whereas a score of 350 may indicate a sell condition whereas a score of 900 may indicate a buy conditions. The score result may be a composite of scores of sub-classes based on which you can either BUY, HOLD, or SELL a particular stock.

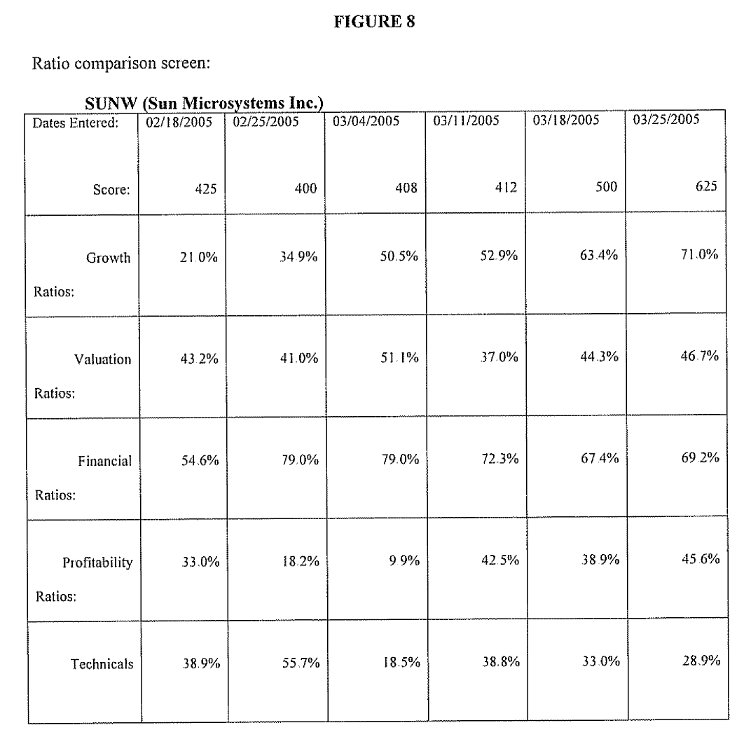

To further assist the user in selecting securities for a specific portfolio, the scoring system may be further broken down into subcategories. For instance, a user may want to know what the particular ratio history is for a fundamental subcategory variable (growth, valuation, financial, profitability), which gives the results percentile for a specific score for a set of dates. A ratio comparison screen is illustrated in FIG. 8. Ratio history evaluates the relative performance of the stock in terms of percentiles. Other options may include a comparison of the fundamental calculations of the selected security to the fundamentals of stocks in a particular industry.

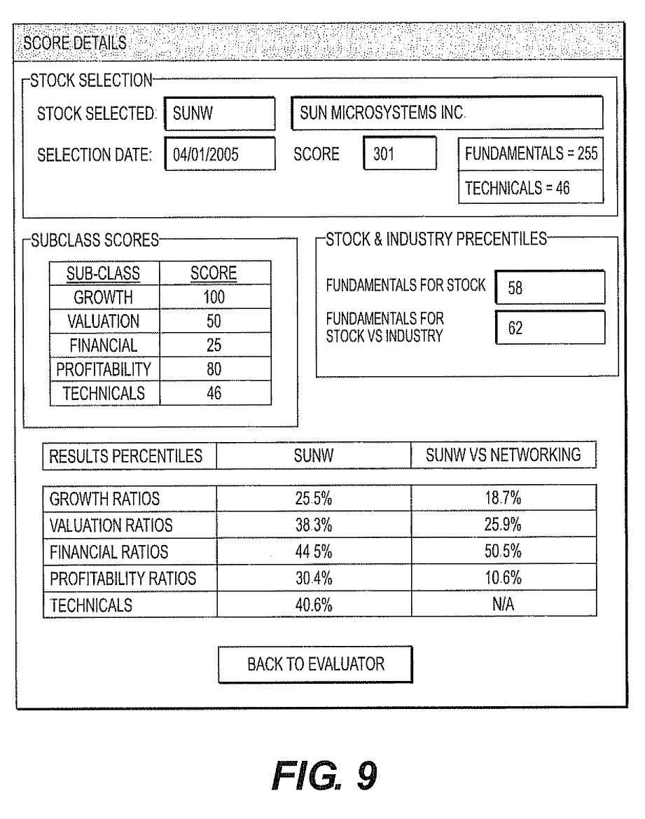

In another preferred embodiment of the present invention, as discussed above, the user may retrieve a detailed summary of the fundamental and technical variables. This detailed summary is illustrated in FIG. 9. A broad-level break up of score along Fundamentals and Technicals is captured in a summary. The Fundamentals for Stock and Fundamentals for Stock versus Industry in terms of Percentiles are shown under the heading “Stock and Industry Percentiles,” Under the heading “Subclass scores,” a detailed break-up of the score along subclasses is illustrated. A further break-up Fundamentals for Stock and Fundamentals for Stock versus Industry, in terms of Percentiles, along Sub-Classes are also shown in FIG. 9. The industry sector under which the stock lies can be seen (“networking” in this example). In case of Technical Variables, the derivation of stock performance with reference to Industry performance in terms of percentiles is not applicable. Therefore the concerned field shows the output as N/A.

In another preferred embodiment of the present invention, the fundamentals for a particular stock and the fundamentals for a particular stock as compared to the industry are further analyzed in terms of percentiles along sub-classes, i.e., growth, valuation, financial, profitability, and technicals. This is also illustrated in FIG. 9. Therefore, the security is scored not only on its own but also as compared in a relative value to the index. Thus, not only does the user have the ability to analyze the individual performance of the security, but the user can further analyze the performance of the security as compared to the industry and in particular sub-classes, as shown in the tables below:

The ability to score stocks based upon weighting certain variables not only allows a greater degree of freedom when selecting stocks for a portfolio, the particular weights for a given investing strategy constitute valuable business intelligence gained through data collection and experience.

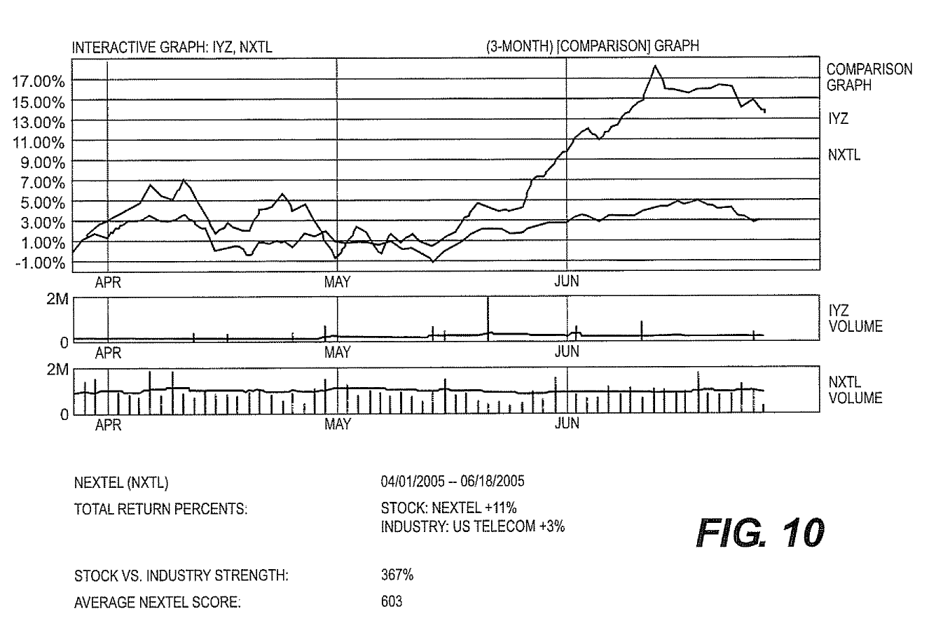

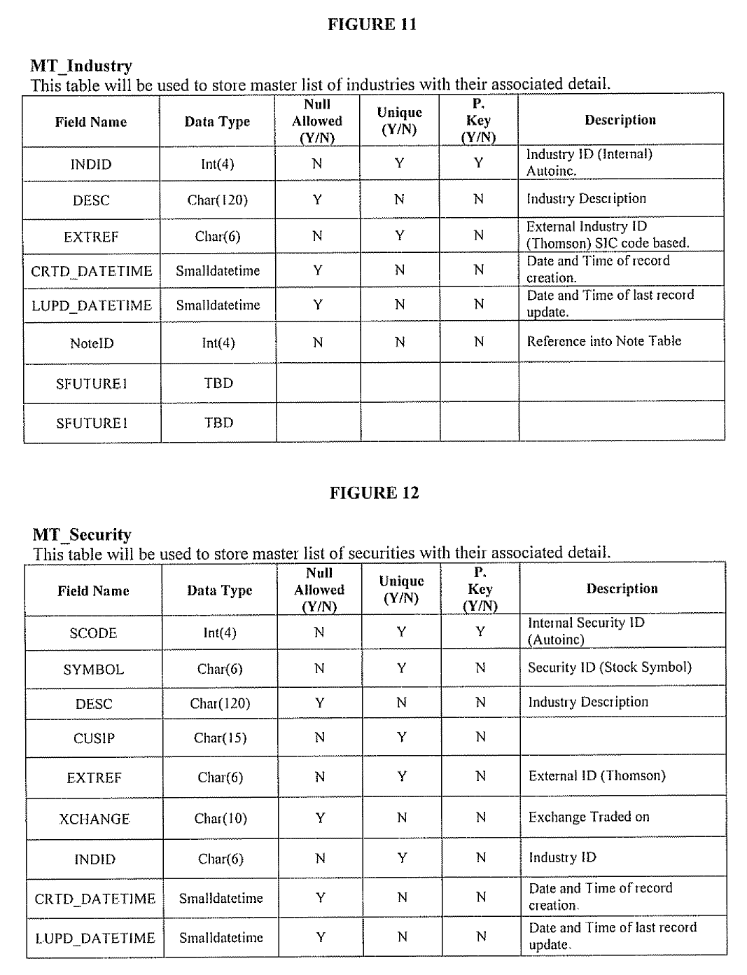

In addition to the scoring discussed above, embodiments of the invention enable a user to enter a stock symbol and any two dates to get multiple chart data for the stock over the selected time frame. As illustrated in FIG. 10, the charts may show: stock price changes over the two dates; comparison of industry index and the price movement; and the percent change of the stock's scores with the percent change of the price over the entered time frame. The following information may be displayed in a table below the chart (as also illustrated in FIG. 10): total return percentage for the stock; the return for its industry/index; stock versus industry return differential; and the average score.

A setup screen typically maintains any setup information that is used by the system to perform its functions. Some of the items maintained in this screen include (but not be limited to) the following: address, user ids and passwords for FTP file download from Thompson; directory for downloaded file storage; process scheduling data; data retention options; and other items.

An industry maintenance screen is typically used to maintain the industry master records and provides a reference for associating a security to its corresponding industry. The fields in the MT_Industry table (illustrated in FIG. 11) are maintained in this screen Field INDID is automatically generated by the system.

A security maintenance screen is typically used to maintain master records of securities to be evaluated with their associated detail. All of the fields in the MT_Security table (illustrated in FIG. 12) are maintained in this screen. The following list identifies additional data for some of the fields: SCODE—is automatically generated by the system; INDID—is a foreign key into MT_Industry table; and EXTREIF—is a code used by Thompson to identify this security.

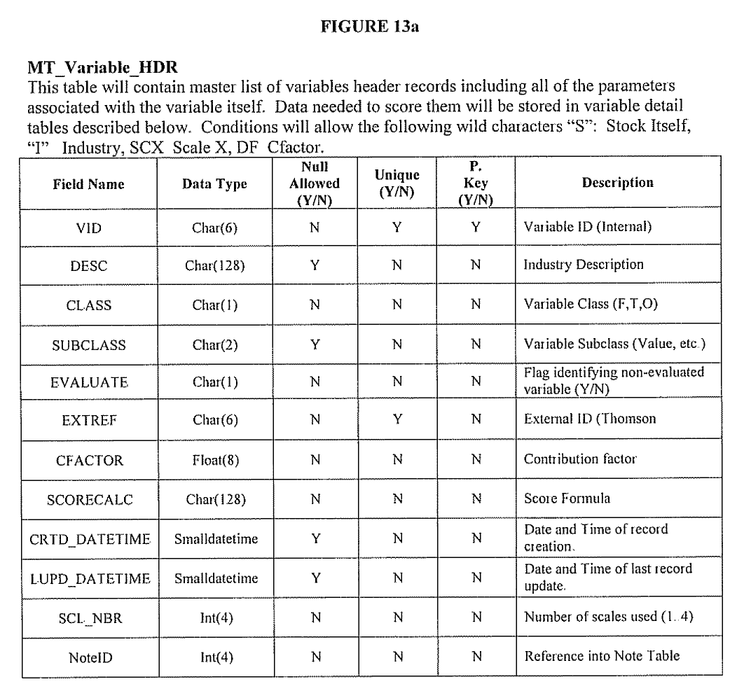

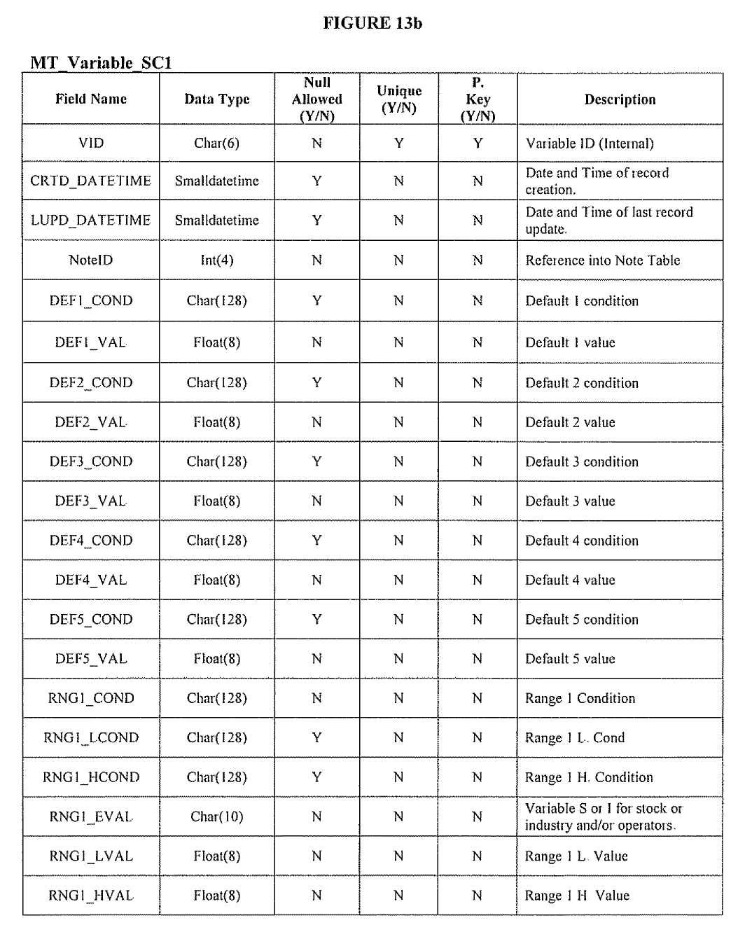

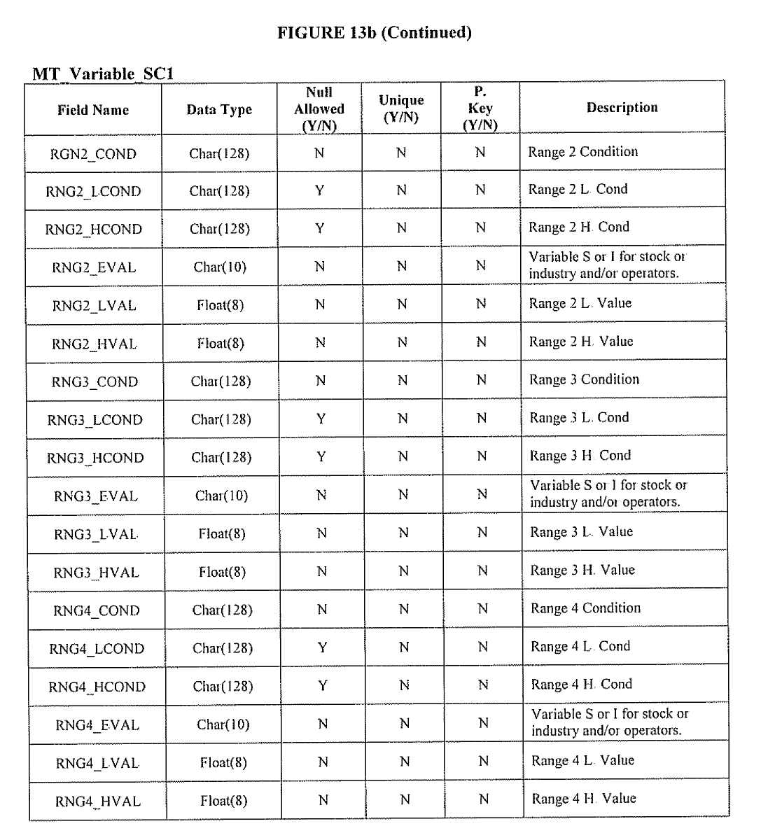

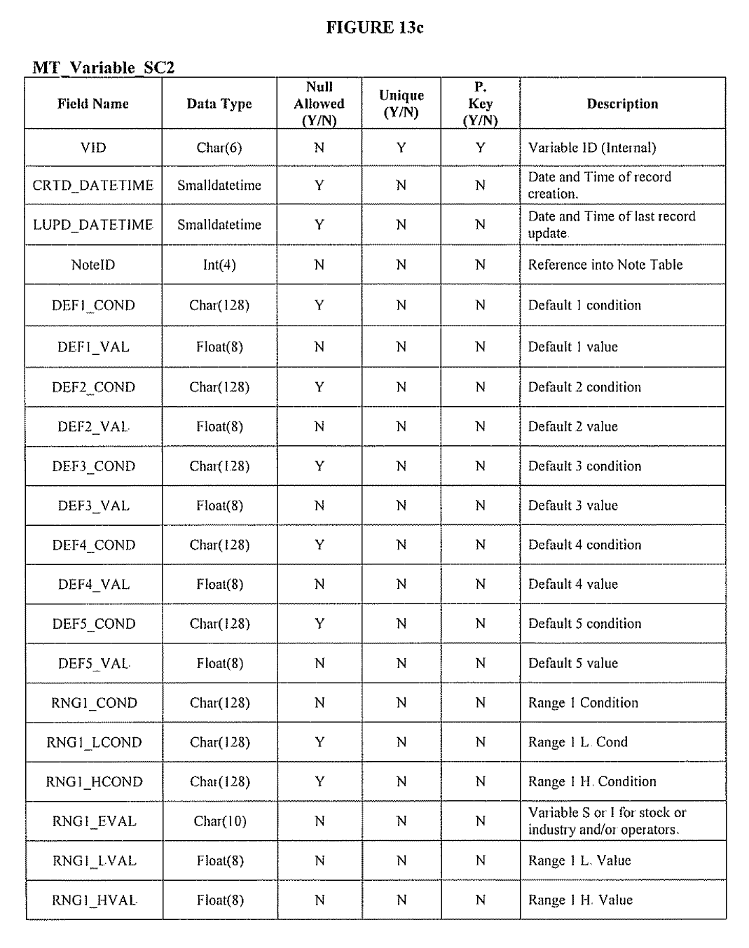

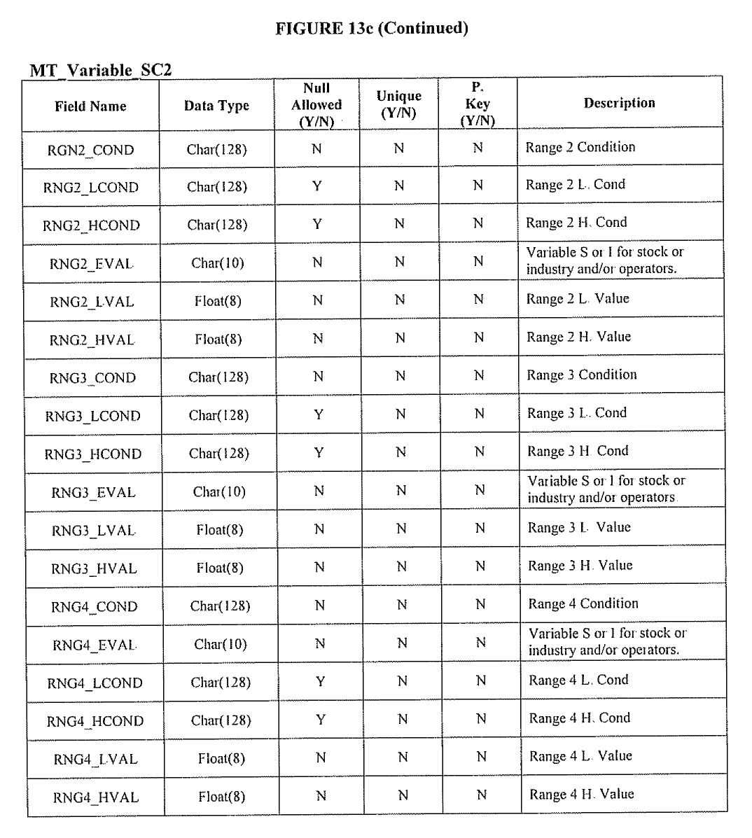

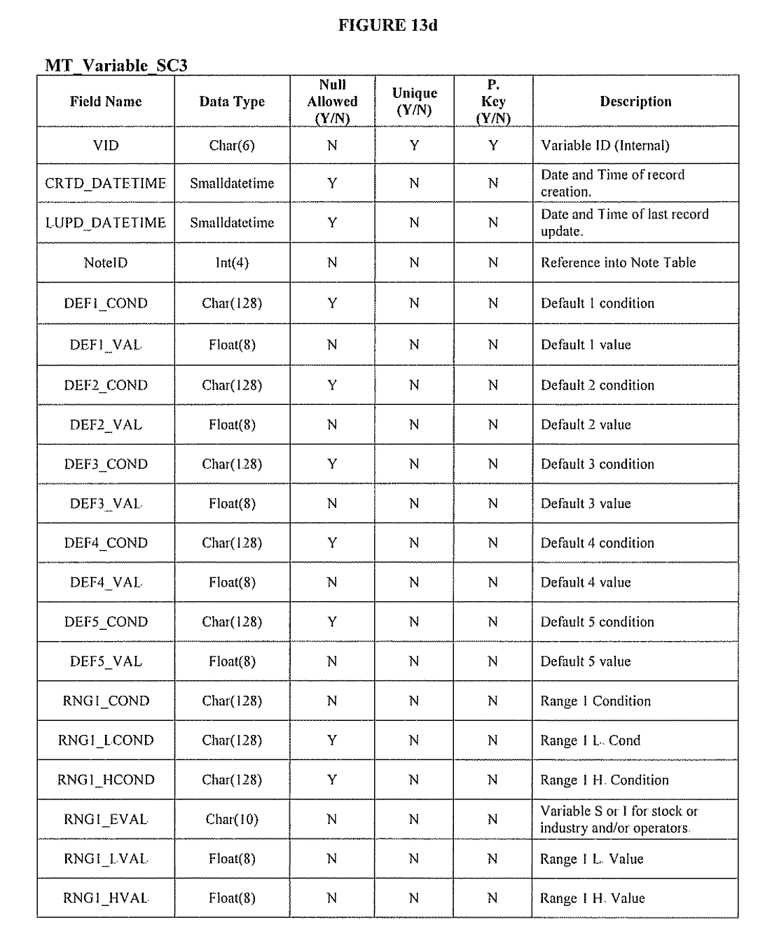

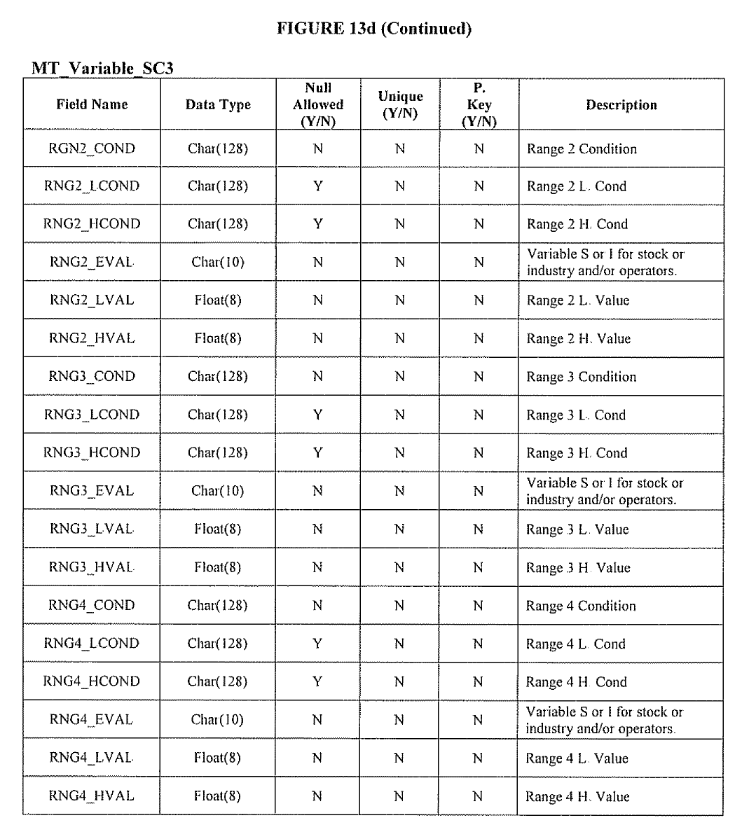

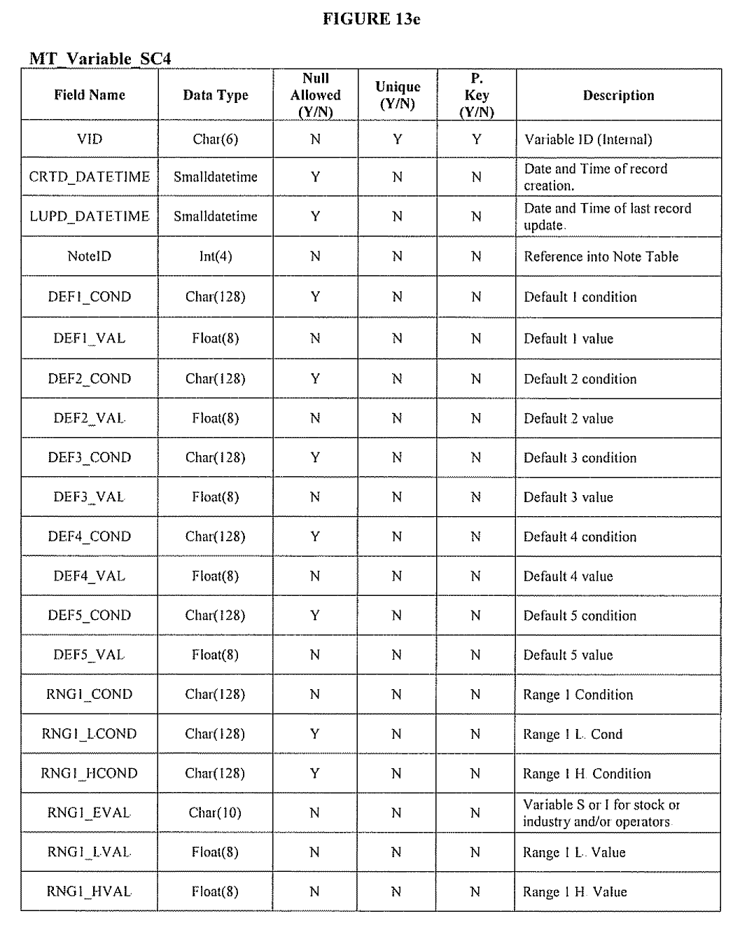

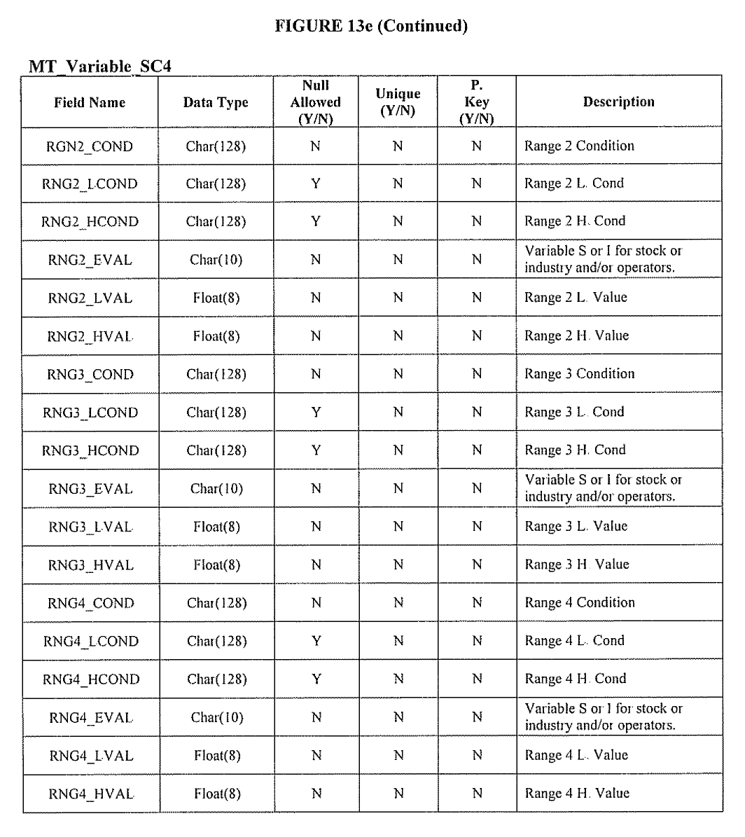

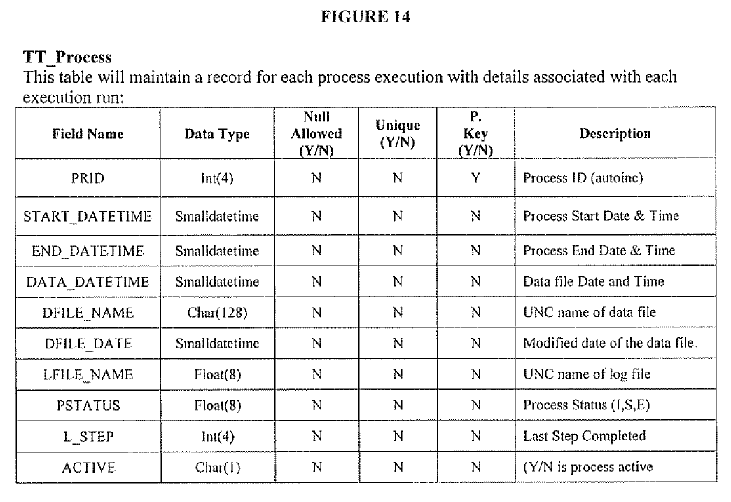

A variable maintenance screen maintains all of the data associated with each variable, Screen maintains the general variable data as well as all valuation related detail. More specifically all fields in the following tables (illustrated in FIG. 13a-13f) are maintained by this screen:

a. MT_Variable_HDR

b. MT_Variable_SC1

c. MT_Variable_SC2

d. MT_Variable_SC3

e. MT_Variable_SC4

The MT_Variable_HDR table contains master list of variables header records (MT_Variable_SC1, SC2, SCC3, SC4) including all of the parameters associated with the variable itself. Data needed to score them is stored in variable detail tables described below. Conditions allows the following wild characters “S”—Stock Itself, “I”—Industry, SCX—Scale X, CF—Cfactor.

The following list identifies additional date for some of the fields in the tables illustrated in FIGS. 13a-13f:
a. VID—is automatically generated by the system
b. EXTREF—is a code used by Thompson to identify this variable.

c. DEF1_COND . . . DEF5_COND—Boolean expression determining if the specific default is to be used. Same for all scales.
d. DEF1_VAL . . . DEF5_VAL—Default value to use if selected. Same for all scales
e. RNG1_COND . . . RNG4_COND—Boolean expression determining if the specific range is to be used. Samne for all scales.
f. RNG1_LCOND, RNG1 . . . HCOND . . . RNG4_LCOND, RNG4_HCOND—Low and high conditions for the ranges expressed as “I=20” or “S=20” (I and S represent stock and industries variable input value). Matching H-JAVAL and LVAL must use the same (S or I variable). Same for all scales.
g. RNG1_LVAL, RNG1_HAVAL . . . RNG4_LVAL, RNG5_HAVAL—Low and high values for range, used for evaluation. Same for all scales.

A process manager screen facilitates actual management of the evaluation process. This screen consists of a grid containing a row for each calculation run. Sort Order and Sort fields are user selectable. This screen allows user to perform the following functions activated by buttons (when context required currently selected row is used). Each data row displays the following fields:
a. Process id
b Date
c. Status
d. Last step executed (or executing for current)
e. Last record processed 0 for the current step for completed steps
f. Total number of record for the process
g. Evaluation date
h. Run date and time
i. Duration
j. Data file name
k. Other

The following is the list of button-activated functions that may be available on this screen (not illustrated):
a. View Log—this function activates a log view screen ad display all log records generated for selected process
b. Restart Process—this function allows user to restart a process that failed to complete. The system attempts to restart from the point of failure
c. Recalculate—this function allows the user to delete all data associated with the current process and repeat the entire evaluation process. User is typically required to select the down loaded (file typically needs to be downloaded manually)

The process data is contained in the TT_Process, which maintains a record for each process execution with details associated with each execution run:

A process log view screen displays (read-only) the contents of the log header and detail tables for a specific process. The screen contains two grids one listing header records with one row for each step in the process and the detail area that is relative to the selected header record.

A result maintenance screen allows for review and manual edit of the resultant data. The screen consists of selection area where user identifies security and the data date. Once selected the lower portion of screen, consisting of a grid, displays resultant data with one row per variable displaying the following fields:
a. Variable ID—read-only
b. Variable Description—read-only
c. Scale1 score—editable
d. Scale2 score—editable
e. Scale3 score—editable
Scale4 score—editable
g. P Factor—editable
h. Calculation formula—editable

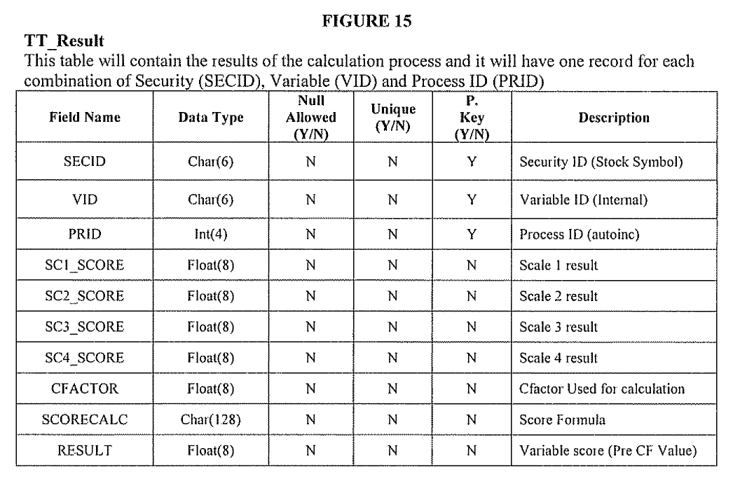

The results are contained in the TT_Result table, illustrated in FIG. 15. This table contains the results of the calculation process and it has one record for each combination of Security (SECID), Variable (VID) and Process ID (PRID).

A customer account maintenance screen is used to maintain customer accounts, passwords and consists of two sections:
1. Customer data—this section of the screen maintains customer specific data and includes the following fields:
   a. User ID
   b. Password (Hlashed-display)
   c. Contact Name
   d. Business Name
   e. Address
   f. Account creation date
   g. Termination date
   h. Status
   i. Other
2. Variables Exposed—this section of the screen maintains variables that is made visible to this customer account and their weighted percentages (total percentage must add up to 100).

The customer portal includes the system components that facilitate the deliver of the customer facing screen via WEB browser as well as all communication components.

The communication layer component comprises a WEB Service that facilitates the delivery of the requested result to a remove application. WEB service communication model was selected to facilitate disconnected client and make data delivery model client independent. Using this methodology allows the use of a full browser screen as well as data delivery in the future to clients like major commercial (Ex: Yahoo, MSNBC, etc.) sites, PDA devices, and any other internet enable clients. In addition, this model allows for the actual client site to be hosted commercially and have the back office components of the systems be physically separated from the hosted site.

The security research screen facilitates the function of customer stock valuation retrieval. The screen consists of two selections:
1. Input and Results—this section of the screen consists of a grid that allows user to enter stock symbols into the first column and to enter a series of dates (to report on) into the top row. The system returns the data for the stocks and dates selected, upon press of a button
2. Drill Down—this section of the screen displays the detailed data for the stock/date selected and includes the following elements:
   a. Score based on the stock itself
   b. Score based on industry
   c. Scores by each variable subclass (EX: Value, Growth, etc.)

Because of the data derived in the tables discussed above, a preferred embodiment of the present invention is also a business method wherein a user can pay a license or access fee and, instead of having to attempt to determine which variables should be active and the weight given to each active variable, the user can simply pay a licensing fee to gain access to predetermined variables and their weights

Having, thus, described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

That which is claimed:

1. A system for analyzing individual stocks using variables, said system comprising:
a means for selecting variables, the variables selected from the group consisting of fundamental variables and technical variables;
a means for assigning weights to said variables;
a means for downloading data corresponding to said individual stocks; and
a means for evaluating said variables using said downloaded data.

2. The system as claimed in claim 1 wherein variables are selected based on desired portfolio management goals and styles.

3. The system as claimed in claim 1 wherein the fundamental variables are selected from the group consisting of; financials; valuations; profitability; and growth.

4. The system as claimed in claim 2 wherein the weighted variables are chosen to obtain a simulation of stock performance.

5. The system as claimed in claim 4 wherein the simulated stock performance is a score.

6. The system as claimed in claim 5 wherein the score is a number used to determine a recommendation of at least one of buy, hold and sell.

7. The system as claimed in claim 5 wherein each of the chosen variables is assigned a portion of the score.

8. The system as claimed in claim 7 wherein the score is determined by the assigned weight to each of the selected variables.

9. The system as claimed in claim 8 wherein the assigned weights are percentages that total 100%.

10. A method for analyzing individual stocks using variables, said method comprising:
selecting desired variables from the group consisting of fundamental variables and technical variables;
assigning weights to said variables;
downloading data corresponding to said individual stocks; and
evaluating said variables using said downloaded data.

11. The method as claimed in claim 10 wherein variables are selected based on desired portfolio management goals and styles.

12. The method as claimed in claim 10 wherein the fundamental variables are selected from the group consisting of; financials; valuations; profitability; and growth.

13. The method as claimed in claim 11 wherein the weighted variables are chosen to obtain a simulation of stock performance.

14. The method as claimed in claim 13 wherein the simulated stock performance is a score.

15. The method as claimed in claim 14 wherein the score is a number used to determine a recommendation of at least one of buy, hold and sell.

16. A computer program for analyzing individual stocks using variables, said computer program comprising:
a first instruction set for selecting desired variables, the variables selected from the group consisting of fundamental variables and technical variables;
a second instruction set for assigning weights to said variables;
a third instruction set for downloading data corresponding to said individual stocks; and
a fourth instruction set for evaluating said variables using said downloaded data.

17. The method as claimed in claim 16 wherein variables are selected based on desired portfolio management goals and styles.

18. The method as claimed in claim 16 wherein the fundamental variables are selected from the group consisting of: financials; valuations; profitability; and growth.

19. The method as claimed in claim 17 wherein the weighted variables are chosen to obtain a simulation of stock performance.

20. The method as claimed in claim 19 wherein the simulated stock performance is a score used to determine a recommendation of at least one of buy, hold and sell.
